(19) United States
(12) Patent Application Publication
(10) Pub. No.: US 2008/0020210 A1
(43) Pub. Date: Jan. 24, 2008

(54) Metallized multilayered composite

(76) Inventors: Patrick J. Griffin, Coraopolis, PA (US); Stephan G. Smith, Bethel Park, PA (US); Amy S. Wylie, Aliquippa, PA (US); Kenneth K. Schwartz, Great Barrington, MA (US); Peter D. Schmitt, Beaver, PA (US); Lyubov K. Gindin, Pittsburgh, PA (US); William A. Corso, Coraopolis, PA (US)

Correspondence Address: BAYER MATERIAL SCIENCE LLC, 100 BAYER ROAD, PITTSBURGH, PA, 15205, US

(21) Appl. No.: 11/489,110

(22) Filed: Jul. 19, 2006

(51) Int. Cl. B32B 27/40; B32B 27/36; B32B 15/08

(52) U.S. Cl. 428/412; 428/457; 428/423.1; 428/458; 428/461; 428/463

(57) ABSTRACT

A formable multi-layered composite comprising in sequence a clear polymeric layer, a metal layer, and a protective layer is disclosed. The polymeric layer including at least one member selected from the first group consisting of polycarbonate, PETG, PCTG polystyrene and polyurethane. The metal layer contains at least one member selected from the group consisting of titanium, aluminum, copper, silver, chromium, zirconium, tin, indium and their alloys. The protective layer that contains an aliphatic polyurethane dispersion based on at least one member selected from among polycarbonate polyol and polyether polyol protects the metal layer during handling and use in the context of FIM.

### FIELD OF THE INVENTION

The invention relates to a multi-layered composite and more particularly to a composite containing a polymeric film and at least one metal layer.

### BACKGROUND OF THE INVENTION

Metallized plastic articles are known. Included are films that carry a metal layer applied to the surface of film by vacuum deposition, electrolysis or electroless depositions. Also known is the use of such metallized films as film inserts in injection molding application (FIM) where the metal layer provides decorative and/or reflective appearance to the molded article.

Film Insert Molding (FIM), also known as In Mold Decorating (IMD) refers to a method of applying printed graphics to injection molded plastic parts. FIM may be used to apply clear scratch-resistant hardcoats, logos, text and graphics in any color or combination of colors to plastic parts prior to injection molding. This technique has been described in, e.g., U.S. Pat. No. 5,783,287, and is widely practiced. Essentially, the method entails positioning a film against the inside wall of a mold cavity and injecting molten plastic into the mold cavity, directing the molten plastic against the film. As a result, a predetermined portion of the surface of the resulting molded article is covered by the film.

In instances where the configuration of the molded article requires straining the metallized film beyond its elastic limit, the metal often separates from the film and the resulting FIM-produced article is aesthetically compromised

A multilayer, metal/organic polymer composite, exhibiting high specular reflectivity even after substantial elongation has been disclosed in U.S. Pat. Nos. 4,115,619 and 4,211,822. A layer of thermoplastic organic polymers such as polystyrene or polycarbonate film is metallized with a normally solid, soft metal such as indium or an alloy of tin and cadmium. The multilayer composite or a portion thereof is said to be stretched or elongated by more than 10 percent in both the longitudinal and traverse directions without losing its initial specular reflectivity. Articles fabricated of the multilayer composite may be structurally reinforced by casting an elastomeric or rigid foam polymer such as polyurethane into a cavity.

U.S. Pat. No. 5,353,154 disclosed a multilayered thermo-formable reflective body that is capable of being fabricated into a number of parts while maintaining a uniform reflective appearance. It is formed from at least two diverse polymeric materials differing in their respective refractive indices. The polymeric body is said to be reflective in appearance yet transparent or, colored upon illumination from a back light source.

A metal/organic polymer composite exhibiting excellent resistance to delamination, including under conditions of thermoforming is said in U.S. Pat. No. 4,241,129 to be provided by metallizing a substrate layer of thermoplastic organic polymer such as polycarbonate film and bonding the exposed metal surface to a structural plastic with a soft adhesive layer. Subsequently, the multilayered composite is said to be capable of being shaped into an article which may be structurally reinforced by casting an elastomeric or rigid foamed polymer into a cavity defined by the composite. These multi-layered composites are said to be useful in the manufacture of reflective and decorative parts for automobiles, as well as high barrier packages for foods and electroconductive elements.

In accordance with its abstract, JP 59038238 disclosed a film produced by sputtering indium oxide-tin oxide alloy on plastics film. The alloy contained 8 to 14 wt. % tin. Polyester, polycarbonate and polyamides are mentioned among the suitable plastic films. The film, having good etching processability and evaporated film-adherence is said to have visible light-transmittance of above 80% and thickness of 20 to 200 microns. The film is said to have good chemical and mechanical resistance, and to be used as EL electrode and touch panels.

Laminate for decorative molding products, having a thin metallic film layer, formed on film base material has been disclosed in the abstract of JP 2000094575 A. The metal, indium or indium alloy has a thickness of 10 to 30 nm. The film base material is polyester having at least 85 mol% ethylene terephthalate. The thickness of the film is 20 to 75 microns. The indicated use of the laminate is for decorative molding products made of, among others, polycarbonate. An advantage is noted to be the avoidance of crack generation on the decorative molded article, as the laminate which has thin metal film formed on film base material, is used as a decorative integral laminate for providing metallic luster on the molded article during injection molding.

### SUMMARY OF THE INVENTION

A formable multi-layered composite comprising in sequence a clear polymeric layer, a metal layer, and a protective layer is disclosed. The polymeric layer including at least one member selected from the first group consisting of polycarbonate, PETG, PCTG, polystyrene and polyurethane. The metal layer contains at least one member selected from the group consisting of titanium, aluminum, copper, silver, chromium, zirconium, tin, indium and their alloys. The protective layer that contains an aliphatic polyurethane dispersion based on polycarbonate polyol and/or polyether polyol protects the metal layer during handling and use in the context of FIM. A method of using the inventive composite is also disclosed.

### DETAILED DESCRIPTION OF THE INVENTION

A multi-layered metal/organic polymer composite exhibiting desirable decorative and forming characteristics is disclosed. The composite includes as essential components a polymeric layer, a metal layer, and a protective layer. The inventive composite is formable, a feature that in the present context means that it is capable of being formed without delamination or separation of the metal layer from the polymeric substrate. By “forming” we mean that at least a portion of the inventive composite is stretched to undergo a significant dimensional change. Quantitatively, at least a portion of the area of the composite may be extended by at least 5 percent without exhibiting objectionable micro cracks that adversely affect the mirror-like appearance of the formed composite. The inventive composite may be thermoformed to produce a formed insert for making a part by FIM. The protective layer of the inventive composite was found to adhesively bond to the solidified injected resin. In the instances where ink is applied to the protective layer, both the ink and the layer adhere to the molded article.

The clear polymeric layers of the inventive composite may be prepared by conventional means of polycarbonate, Polycyclohexylenedimethylene terephthalate glycol (PCTG), PETG, PMMA, polystyrene, polyurethane and clear blends of these resins. In the context of the invention the terms clear refers to total light transmission greater than 90% and haze value of not greater than 1.5% as determined in accordance with ASTM 1003 method B. These materials and films thereof are known and are available in commerce. In the preferred embodiment the polymeric layer is polycarbonate or a composition that contains polycarbonate. Suitable such polycarbonate films are available commercially under the trademarks Makrofol and Bayfol from Bayer MaterialScience LLC, of Pittsburgh, Pa. Polycarbonate film is preferred because of its high light transmittance, low haze, impact resistance and high heat deflection temperature. Furthermore, polycarbonate film is particularly suitable in applications where printing by conventional techniques such as screen and offset printing is desired. Moreover, polycarbonate film may be easily formed, stamped, die-cut, and embossed.

The polymeric layer needs to be sufficiently thick to enable forming the composite and is generally in the range of 100 to 1,000 microns, preferably 125 to 750 microns, most preferably 175 to 625 microns in thickness. At least one of the surfaces of the polymeric layer, the surface to be metallized needs to be glossy. The other surface may be glossy, matte, velvet or suede. Having glossy finish for both surfaces of the polymeric layer is preferred because this highly transparent layer with the underlying metallic layer provides a bright mirror-like appearance.

The metal layer comprise an alloy of Indium, Tin and Copper, preferably Indium-Tin, most preferably an Indium-Tin-Copper alloy. Preferably, the Indium-Tin-Copper contains Indium in an amount of 5 to 100, more preferably 85 to 95 percent, Tin in an amount of 1 to 95, more preferably 5 to 15 percent and Copper in an amount of 1 to 15, more preferably 5 to 10 percent, the percents being relative to the weight of the alloy. These known alloys are suitably ductile and does not form an oxide film in moist environment and are thus suitable for metallizing the polymeric layer in the context of the invention. The proximity of their melt temperatures to the temperatures at which conventional forming takes place make these alloys particularly suitable for the preparation of the formed composites of the invention.

The protective layer of the inventive composite is formed of an anionic and/or nonionic aliphatic dispersion of polycarbonate urethane resin. This layer provides improved abrasion-resistance and promotes the adhesion of inks and/or injection molding resins to the metallic layer. This suitable dispersion (herein PUD) is characterized in solids contents of about 20 to 60%, preferably 30 to 50% more preferably 33 to 37%; viscosity, at 25° C. of 10 to 3000 cps, preferably 10 to 1000, more preferably 20 to 400; pH of 6 to 12 , preferably 7 to 9; glass transition temperature of −65 to −25° C., preferably −27 to −37° C. N-Methyl-2-Pyrrolidone (NMP) in an amount of 0 to 15, preferably 6 to 10, most preferably 8% percent by weight may be included in the course of synthesis, or in the alternative may be blended with the suitable PUD. NMP is preferably included in the course of synthesis. Methods for preparing PUD are well known and suitable ones are available commercially from Bayer MaterialScience LLC.

The PUD may optionally contain efficacious amounts of conventional functional additives known for their utility in enhancing adhesion and clarity. Suitable additives include wetting agents, e.g. polyether modified polydimethylsiloxane, flow agents, e.g., polyether-modified methyl polysiloxane.

The multi-layered composites of the present invention may be prepared by any conventional method for making multi-layered metal/organic polymer composites. For example, the metal may be applied as a coating by a conventional metallization technique such as an electroless process described by F. A. Lowenheim in “Metal Coatings of Plastics,” Noyes Date Corporation, (1970), by Pinter, S. H. et al., Plastics: Surface and Finish, Daniel Davey & Company, Inc., 172-186 (1971) or in U.S. Pat. No. 2,464,143. An especially preferred metallization technique in the practice of this invention is a vacuum deposition technique wherein the metal is vacuum evaporated and then deposited onto the polymer layer as described by William Goldie in Metallic Coating of Plastics, Vol. 1, Electrochemical Publications Limited, Chap. 12 (1968). Another preferred metallization technique includes sputter coating as described in Chapter 13 of Goldie, supra. Also suitable is electroplating and ion plating. In addition, the multi-layered composite may be formed by lamination of metal foil to the polymer layer including extrusion coating of the polymer layer onto a metal foil.

The thickness of the metal layer in the multi-layered composite is that which would form a reflective, essentially continuous film over the surface of the polymer layer the metal layer enabling light transmittance through the metallized polycarbonate film. When light transmittance, determined in accordance with ASTM D1003 method B, is higher than 60%, the metal layer loses its shininess and appears brownish in color. Preferably, light transmittance is in the range of 0.1% to 60.0%, most preferably 0.2% to 40%. When the metallized composite is used in a backlit application, preferred light transmittance ranges from 0.3% to 30%, most preferably 1.4% to 25%.

Following its preparation the multi-layered composite may be formed by a conventional forming process, e.g., thermoforming or solid phase forming, to the desired shape. Preferably, the forming process is a conventional thermoforming process for shaping sheet or film stock, which process is normally carried out at an elevated film surface-temperature. In forming composites wherein the polymeric layer is of polycarbonate the surface-temperature of the film is about 190° C. Exemplary thermoforming processes include differential air pressure thermoforming, match thermoforming, vacuum forming, plug assist-vacuum forming, draw forming, impact forming, rubber pad forming, hydroforming, drape molding and the like. Exemplary solid phase forming methods include cold rolling, impact extrusion, forging, forward extrusion, cold heading, and rubber-pad forming, e.g., as such methods are further described by P. M. Coffman in Soc. Plas. Eng. Journal, Vol. 25, January, 1969 (50-54) and Soc. Auto. Eng. Journal, Vol. 76, No. 6, 36-41 (1968), all incorporated herein by reference.

In the forming operation, the entire composite or a portion thereof, is formed or shaped in a manner such that at least a portion of the composite undergoes a cumulative surface dimensional change of at least 5 percent. The term “cumulative surface dimensional change” refers to the combined change of length and width wherein a decrease as well as an increase in a particular dimension is treated as a positive change. Either one or both surface dimensions may be changed in the forming operation. Techniques for observing surface dimensional changes are described by A. Nadai in Plasticity, McGraw-Hill (1931). The formed composite may be die-cut and then molded using Film Inset Molding technology. U.S. Pat. Nos. 3,654,062 and 6,117,384 that relate to Film Insert Molding, or as it is sometimes referred to In Mold Decoration, are incorporated herein by reference.

The method of using the inventive multi-layered composite entails the technology known as FIM or in-mold-decoration. Essentially the method entails forming the composite to produce a formed composite, placing the formed composite in a mold, and introducing molten resin into the mold to form an article that includes the formed composite.

The following examples illustrate the invention and should not be construed as limiting the scope thereof.

### Experimental

To a polycarbonate film (0.010″ thick) metallized with an alloy of In/Sb (90/10) there was applied, on the metallized side, a protective coating of the composition described below. The thus protected metallized composite was formed and its adhesive integrity evaluated. Each of the polyurethane dispersions that are described in Table 1 was applied in its “as supplied” or blended with one or more additives or with another polyurethane dispersion. These were hand mixed at room temperature and applied to the metal layer using a draw down method. A #34 Mayer rod was used in sequence 1 and a #30 rod was used in sequences 2 and 3.

The examples referred to as Sequence 1 were air-dried at room temperature for 24 hours.

The examples referred to as sequences 2 and 3 were dried at 90° C. for 5 minutes in a continuous air-impinged, high velocity tunnel jet dryer.

Adhesion testing identified failures in the interfaces between the polymeric layer and metal layer or between it and the protective layer. Multi-layered structures measuring 2×3″ were cut and used for making molded specimens by FIM, polycarbonate (Makrolon® 2458 resin, a product of Bayer MaterialScience LLC) being injection molded behind the multilayered composite. The resin temperature was 290° C., mold temperature was 50° C. , and the injection speed was 50 mm/s. The molded samples were then post cured for 24 hours at room temperature.

The specimens referred to as sequence 1 were tested for adhesion by hand pulling a corner of the film to determine where the failure occurred. The integrity of the adhesion in the examples of sequences 2 and 3 was determined in accordance with ASTM D429, method B, 90° peel test at 305 in/min., and the results were reported in lb/in.

### Experimental Sequence 1

In this sequence the polyurethane dispersions were used as protective layer and evaluated, the description and results are shown in Table 1.

TABLE 1

| Example | Coating formulation | comments | Result |
|---|---|---|---|
| 1 | Polyester-based PUD1 | molded well but complete | Fail |
| | | adhesion loss after cooling | |
| 2 | Polycarbonate-based | good adhesion | Pass |
| | PUD2 | | |
| 3 | Polycarbonate-based | coating and metal pull | Pass |
| | PUD3 | away from PC but tough | |
| | | to pull apart | |

Footnotes:
PUD1 - denotes a PUD based on polyester, solids content 33–37%; viscosity at 25° C. 50 to 300 cps; pH 7.5 to 9.5; 15% of NMP co-solvent, and T_{g} −22° C. (e.g. Bayhydrol 110 dispersion, a product of Bayer MaterialScience LLC).
PUD2 - denotes a PUD based on polycarbonate, solids content 33–37%; viscosity at 25° C. 50 to 400 cps; pH 7 to 9; 15% of NMP co-solvent, and T_{g} −9° C. (e.g. Bayhydrol 121 dispersion, a product of Bayer MaterialScience LLC).
PUD3 - denotes a PUD based on polycarbonate, solids content 33–37%; viscosity at 25° C.50 to 400 cps; pH 7 to 9; 12% of NMP co-solvent, and T_{g} −32° C. (e.g. Bayhydrol 124 dispersion, a product of Bayer MaterialScience LLC).

### Experimental Sequence 2

In a still additional series of tests the effects of alternative co-solvent on the adhesion were determined. Alternative solvents such as IPA and Ethanol, were post added. The examples and the resulting adhesions are shown in Table 2.

TABLE 2

| | | peel average | peak peel |
|---|---|---|---|
| Example | coating formulation | (lb/in) | (lb/in) |
| 4 | PUD3 | 3.57 | 4.40 |
| 5 | PUD7 | 2.06 | 2.51 |
| 6 | PUD7 and 5 wt. % IPA | 1.90 | 2.40 |
| 7 | PUD7 and 10 wt. % IPA | 1.97 | 2.31 |
| 8 | PUD7 and 15 wt % IPA | 1.74 | 2.04 |
| 9 | PUD7 and 5 wt. % Ethanol | 1.82 | 2.33 |
| 10 | PUD7 and 10 wt. % Ethanol | 2.06 | 2.51 |
| 11 | PUD7 and 15 wt % Ethanol | 1.98 | 2.53 |

Footnote:
PUD7 refers to a polycarbonate based PUD; 38–42% solids; viscosity at 25° C. 10–400 cps; pH 6.5–8.5; T_{g} = −35° C.; no-co-solvent (e.g. Bayhydrol XP2637 dispersion, a product of Bayer MaterialScience LLC).

### The results demonstrate the superior adhesion imparted to the inventive system by NMP as the co-solvent of the PUD.

### Experimental Sequence 3

An additional set of experiments showed the dependence of the adhesion on the amount of incorporated NMP in PUD 3 Example 18 entails the addition of PUD6 as adhesion promoter.

TABLE 3

| | | peel average | peak peel |
|---|---|---|---|
| Example | coating formulation | (lb/in) | (lb/in) |
| 12 | PUD3 | 2.62 | 3.67 |
| 13 | PUD7 and 2 wt. % NMP | 1.17 | 1.36 |
| 14 | PUD7 and 4 wt. % NMP | 1.24 | 1.45 |
| 15 | PUD7 and 6 wt. % NMP | 1.18 | 2.31 |
| 16 | PUD7 and 8 wt. % NMP | 1.57 | 2.04 |
| 17 | PUD7 and 12 wt. % NMP | 1.35 | 1.75 |
| 18 | PUD7 and 20 wt. % PUD-6 | 1.73 | 2.27 |

Footnote
PUD6 refers to a polyether-polycarbonate based PUD; 59–61% solids; pH 7–9; T_{g} = −65° C.; no co-solvent (e.g. Impranil DLU dispersion, a product of Bayer MaterialScience LLC).

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A formable multi-layered composite comprising in sequence a clear polymeric layer, a metal layer, and a protective layer, said polymeric layer including at least one member selected from a first group consisting of polycarbonate, PETG, PCTG, PMMA, polystyrene and polyurethane, said metal layer containing at least one member selected from a second group consisting of titanium, aluminum, copper, silver, chromium, zirconium, tin, indium and their alloys, and said protective layer containing an aqueous aliphatic polyurethane dispersion based on at least one member selected from a third group consisting of polycarbonate polyol and polyether polyol.

2. The multi-layered composite of claim 1 wherein said metal layer contains indium.

3. The multi-layered composite of claim 2 wherein said metal layer contains indium-tin alloy that contains tin in a positive amount up to 15 wt. %.

4. The multi-layered composite of claim 2 wherein said metal layer contains indium-tin-copper alloy wherein tin is present in a positive amount of up to 15 wt. % and copper is present in a positive amount of up to 10 wt. %.

5. The multi-layered composite of claim 1 wherein said polymeric layer includes polycarbonate,

6. The multi-layered composite of claim 1 wherein the dispersion is anionic and/or nonionic.

7. The multi-layered composite of claim 6 wherein the dispersion is anionic and nonionic.

8. The multi-layered composite of claim 1 wherein the dispersion is anionic.

9. The multi-layered composite of claim 1 wherein the dispersion is based on polycarbonate polyol.

10. The multi-layered composite of claim 1 wherein the dispersion contains a positive amount of up to 15 percent relative to its weight of NMP.

11. The multi-layered composite of claim 6 wherein the dispersion contains a positive amount of up to 15 percent relative to its weight of NMP.

12. The multi-layered composite of claim 7 wherein the dispersion contains a positive amount of up to 15 percent relative to its weight of NMP.

13. The multi-layered composite of claim 8 wherein the dispersion contains a positive amount of up to 15 percent relative to its weight of NMP.

14. The multi-layered composite of claim 9 wherein the dispersion contains a positive amount of up to 15 percent relative to its weight of NMP.

15. A multi-layered composite comprising in sequence a clear polymeric layer, a metal layer, and a protective layer, said polymeric layer including polycarbonate, said metal layer containing an indium-tin-copper alloy wherein tin is present in a positive amount of up to 15 wt. % and copper is present in a positive amount of up to 10 wt. %, and said protective layer containing an aqueous aliphatic polyurethane dispersion based on polycarbonate polyol.

16. A method of using the multi-layered composite of claim 1 comprising
(i) forming said composite to produce a formed composite,
(ii) placing the formed composite in a mold, and
(iii) introducing molten resin into the mold to form an article that includes said for*med composite.
